(19) United States
(12) Patent Application Publication
(10) Pub. No.: US 2012/0310864 A1
(43) Pub. Date: Dec. 6, 2012

(54) Adaptive Batch Mode Active Learning for Evolving a Classifier

(76) Inventors: Shayok Chakraborty, Tempe, AZ (US); Vineeth Nallure Balasubramanian, Tempe, AZ (US); Sethuraman Panchanathan, Gilbert, AZ (US)

(21) Appl. No.: 13/484,696

(22) Filed: May 31, 2012

Related U.S. Application Data
(60) Provisional application No. 61/491,530, filed on May 31, 2011.

(51) Int. Cl. G06F 15/18

(52) U.S. Cl. 706/12

(57) ABSTRACT

This disclosure includes various embodiments of apparatuses, systems, and methods for adaptive batch mode active learning for evolving a classifier. A corpus of unlabeled data elements to be classified is received, a batch size is determined based on a score function, a batch of unlabeled data elements having the determined batch size is selected from the corpus and labeled using a labeling agent or oracle, a classifier is retrained with the labeled data elements, these steps are repeated until a stop criterion has been met, for example, the classifier obtains a desired performance on unlabeled data elements in the corpus. The batch size determination and selection of a batch unlabeled data elements may be based on a single score function. The data elements may be video, image, audio, web text, and/or other data elements.

### CROSS-REFERENCE TO RELATED APPLICATIONS

This application claims the benefit of U.S. Provisional Patent Application Ser. No. 61/491,530 entitled “Apparatus, System, and Method for Adaptive Batch Mode Active Learning for Evolving a Classifier” filed May 31, 2011, the entire contents of which is incorporated herein by reference without disclaimer.

### BACKGROUND

1. Field of the Invention

This invention generally relates to data classification and more particularly relates to adaptively evolving a classifier using batch mode active learning.

2. Description of Related Art

Effective data classification plays an increasingly important role in real world applications. For instance, a computer vision application based on activity recognition applies a classifier to captured video streams in order to recognize various human activities. To ensure reliable performance of the classifier, it must be trained using a plurality of labeled examples. Such systems often rely on human oracles to manually label the data. Due to the tremendous increase in the amount of digital data, it is impractical for human beings to hand-label large datasets. In order to optimize the labeling effort associated with training data classifiers, active learning algorithms have been implemented which select only the promising and exemplar instances for manual labeling.

Conventional methods of active learning have focused on the pool-based strategy where the learner is presented with a pool of unlabeled data. The active learner applies a query function to select a single instance for labeling. The classifier is then retrained with the newly labeled datum and the process continues until a pre-defined stopping criterion is satisfied. This is not effective due to the time consuming process of retraining the classifier based on every new data point. In addition, multiple labeling oracles may be present simultaneously and selecting a single instance at a time may result in wastage of available resources. To overcome these, batch mode active learning (BMAL) systems have been implemented, which select a batch of unlabeled data points simultaneously from a given data corpus. The classifier is retrained once after every batch of data points is selected and the selection of multiple instances facilitates parallel labeling.

BMAL algorithms are important in applications such as video data. Modern video cameras have a high frame rate and consequently, the captured data has high redundancy. Selecting batches of relevant frames from a superfluous frame sequence in captured videos is a significant and valuable challenge.

A BMAL system can be conceptualized as consisting of two main steps: (i) deciding the batch size (number of data points to be queried from a given unlabeled set of points) and (ii) selecting the most appropriate data points from the unlabeled pool once the batch size has been determined. Both these steps are important in ensuring maximum generalization capability of the learner with minimum human labeling effort, which is the primary objective in any active learning application. However, the existing few efforts on batch mode active learning focus only on the second step of identifying a criteria for selecting informative batches of data samples and require the batch size to be specified in advance by the user. In an application like face-based biometric recognition for example, deciding on the batch size (number of relevant frames in a video) in advance and without any knowledge of the data stream being analyzed, is impractical. The batch size should depend on the quality and variability of the images in the unlabeled stream and also on the level of confidence of the current classifier on the unlabeled images.

Active learning methods can be broadly categorized as online and pool-based. In online active learning, the learner encounters the data points sequentially over time and at each instant it needs to decide whether the current point has to be queried for its class label. In contrast, in pool-based active learning, the learner is exposed to a pool of unlabeled data points and it iteratively selects instances for manual annotation.

Pool-based methods can be sub-categorized as serial query based, where a single point is queried at a time and batch mode, where a batch of points is queried simultaneously before updating the classifier. Majority of the active learning techniques have been applied in the serial query based setting and can be divided into 4 categories: (i) SVM based approaches, which decide the next point to be queried based on its distance from the hyperplane in the feature space (Tong and Koller, 2000), (ii) Statistical approaches, which query points such that some statistical property of the future learner (e.g. the learner variance) is optimized (Cohn et al., 1996), (iii) Query by Committee, which chooses points to be queried based on the level of disagreement among an ensemble of classifiers (Baram et al., 2004; Freund et al., 1997; Liere and Tadepalli, 1997) and (iv) Other miscellaneous approaches (McCallum and Nigam, 1998).

All the aforementioned techniques of batch mode active learning concentrate only on the development of a selection criteria assuming the batch size is chosen by the user in advance. In an application like face-based biometric recognition, this is not a practical assumption. For instance, one would expect the number of relevant frames to be large when the active learner is exposed to an unlabeled video containing many new identities unknown to the learner, and the number to be low when the unlabeled video contains images similar to the training data. Thus, there is a strong need for the active learner to adapt to different contexts and dynamically decide the batch size as well as the specific instances to be queried.

Existing technology on BMAL require the batch size (number of data points to be selected from an unlabeled corpus for manual annotation) to be supplied manually as an input to the system. It is difficult to decide this number without any knowledge of a given unlabeled corpus. Random choice of this number can result in selecting too few data points, with the effect that the current model is not updated accurately; or in selecting too many points incurring considerable human labeling effort to achieve a marginal improvement in the resulting model. Patent Application US 2010/0293117 A1, entitled “Method and System for Facilitating Batch Mode Active Learning,” discloses a method for performing batch mode active learning, wherein a batch of data points is selected from an unlabeled corpus for manual annotation. It assumes that the batch size (number of data points to be selected from an unlabeled data corpus) is supplied as an input to the algorithm. The method then computes a score based on the uncertainty and diversity of each unlabeled data point. The data points with the top k scores (k being the batch size) are selected in the batch. This method has the above described short-comings.

The referenced shortcomings are not intended to be exhaustive, but rather are among many that tend to impair the effectiveness of previously known techniques in performing adaptive BMAL to train a classifier; however, those mentioned here are sufficient to demonstrate that the methodologies appearing in the art have not been satisfactory and that a significant need exists for the techniques described and claimed in this disclosure.

### SUMMARY OF THE INVENTION

Apparatuses, systems, and methods for adaptive batch mode active learning to for evolving a classifier are disclosed. A corpus of unlabeled data elements to be classified is received, a batch size is determined based on an objective function, a batch of unlabeled data elements having the determined batch size is selected from the corpus and labeled using a labeling agent or oracle, a classifier is retrained with the labeled data elements, and these steps are repeated until a stop criterion has been met, for example, the classifier obtains a desired performance on unlabeled data elements in the corpus. Batch size determination and selection of a batch of unlabeled data elements may be based on a single score function. Data elements may be video, audio, image, text and/or other multimedia data elements.

Methods for adaptive batch mode active learning for evolving a classifier are disclosed. In some embodiments, the method comprises: (a) receiving one or more datasets comprising a plurality of unlabeled data elements; (b) determining, using a processor, a batch size; (c) selecting, using the processing, a batch of unlabeled data elements having the batch size from the plurality of unlabeled data elements; (d) labeling, using a labeling agent or oracle, the batch of unlabeled data elements having the batch size; and (e) repeating steps (b)-(e) for the plurality of unlabeled data elements until a stop criterion has been met. A labeling agent may be, for example, a human, a program performing a set of labeling rules, or the like.

In some embodiments, the batch size is determined based on evaluating an objective function. The objective function may be based on distances between a batch of unlabeled data elements having the batch size in the plurality of unlabeled data elements and remaining unlabeled data elements in the plurality of unlabeled data elements. In some embodiment, a batch of unlabeled data elements having a previously determined batch size is selected based on evaluating an objective function. The objective function may be based on distances between a batch of unlabeled data elements having the batch size in the plurality of unlabeled data elements and remaining unlabeled data elements in the plurality of unlabeled data elements. In some embodiments, determining a batch size and selecting a batch of unlabeled data elements having the batch size are based on a single score function. Based on the nature of the application, a different objective function may also be adopted and the same concept can be used for adaptive batch mode active learning.

After the batch of unlabeled data elements having the batch size are labeled, the classifier may be updated by training the classifier with a set of labeled data elements, the set of labeled data elements comprising the batch of labeled data elements having the batch size.

In some embodiments, the plurality of unlabeled data elements may comprise video, image, text, web pages, or other kinds of data.

Systems for adaptive batch mode active learning to for evolving a classifier are disclosed. In some embodiments, the system may comprise a processor, a memory and/or other devices configured to perform: (a) receiving one or more datasets comprising a plurality of unlabeled data elements; (b) determining, using a processor, a batch size; (c) selecting, using the processing, a batch of unlabeled data elements having the batch size from the plurality of unlabeled data elements; (d) labeling, using a labeling agent, the batch of unlabeled data elements having the batch size; and (e) repeating steps (b)-(e) for the plurality of unlabeled data elements until a stop criterion has been met. A labeling agent may be, for example, a human, a program performing a set of labeling rules, or the like.

In some embodiments, batch size is not supplied to the system, and needs to be decided adaptively based on the data corpus. Disclosed methods automatically adjust to the level of complexity of the data and select a batch size accordingly, in addition to selecting the examples. Disclosed methods are adaptive in the sense that the batch size as well as the batch of specific data points are dynamically decided based on the given corpus of unlabeled points. The batch size and the specific data elements to be selected may be simultaneously determined through a single formulation with the same computational complexity as solving one of these problems. Thus, without any extra computational overhead, disclosed methods can dynamically adjust to the data corpus being analyzed.

In some embodiments, batches of unlabeled data points are selected from a corpus so as to optimize the value of a given objective. The objective may be an indication of increase in efficiency of the classifier (which may result if the current batch of points is used to update the classifier) and can be defined suitably based on the application at hand.

For a given objective function, it can be expected that its value will keep improving as one selects more and more data instances for labeling. For instance, if learner uncertainty is a part of the objective function, it will keep decreasing as more points are selected for annotation. This is because, as the learner gets exposed to more and more points, it becomes more confident or less uncertain on unseen data and thus the value of the objective keeps improving with larger batch sizes.

In some embodiments, a penalty on the batch size appended to the objective function to discourage a case which results in a large number of instances for manual annotation and involves significant human labor and defeats the basic purpose of active learning. An objective function with a penalty on the batch size may ensure that any and every data point is not selected in the batch—only points for which the reward of the objective outweighs the penalty, get selected. Therefore, introduction of the penalty term automatically enables the system to strike a balance between data complexity and labeling cost.

Apparatus, systems and methods described herein can be used with any kind of digital data, for example text data (where a model needs to be trained to categorize text documents into different classes based on their contents or to classify an email as spam/non-spam based on its content), web-page classification (where a web-page needs to be assigned into a specific category), content based image retrieval (CBIR) (where relevant images need to be retrieved from a vast collection, based on given keywords), image recognition (where a classifier needs to be developed to recognize images like medical images, objects, facial expressions, facial poses among others).

Any embodiment of any of the devices, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 illustrates one embodiment of a system for adaptive batch mode active learning for evolving a classifier, according to certain aspects of the present disclosure.

FIG. 2 illustrates one embodiment of a database system for adaptive batch mode active learning for evolving a classifier, according to certain aspects of the present disclosure.

FIG. 3 illustrates one embodiment of a computer system that may be used in accordance with certain embodiments of the system for adaptive batch mode active learning for evolving a classifier.

FIG. 5 shows dynamic vs static BMAL on 100 unlabeled video streams from the VidTIMIT datasets (static batch size=10).

FIG. 6 shows dynamic vs static BMAL on 100 unlabeled video streams from the MOBIO datasets (static batch size=10).

FIG. 7 shows dynamic vs static BMAL on 100 unlabeled video streams from VidTIMIT (static batch size=80).

FIG. 8 shows dynamic vs static BMAL on 100 unlabeled video streams from MOBIO (static batch size=80).

FIG. 9 shows a comparison of proposed and clustering-based batch size selection on the VidTIMIT datasets.

FIG. 10 shows a comparison of proposed and clustering-based batch size selection on the MBGC datasets.

FIG. 11 shows a comparison of disclosed method and clustering-based batch size selection on the FacePix Pose dataset.

FIG. 12 shows a comparison of disclosed method and clustering-based batch size selection on the FacePix Illumination dataset.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system or apparatus that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, a device or system that is configured in a certain way is configured in at least that way, but it can also be configured in other ways than those specifically described.

In the following description, numerous specific details are provided, such as examples of programming, software modules, user selections, network transactions, database queries, database structures, hardware modules, hardware circuits, hardware chips, etc., to provide a thorough understanding of disclosed embodiments. One of ordinary skill in the art will recognize, however, that embodiments of the invention may be practiced without one or more of the specific details, or with other methods, components, materials, and so forth. In other instances, well-known structures, materials, or operations are not shown or described in detail to avoid obscuring aspects of the invention.

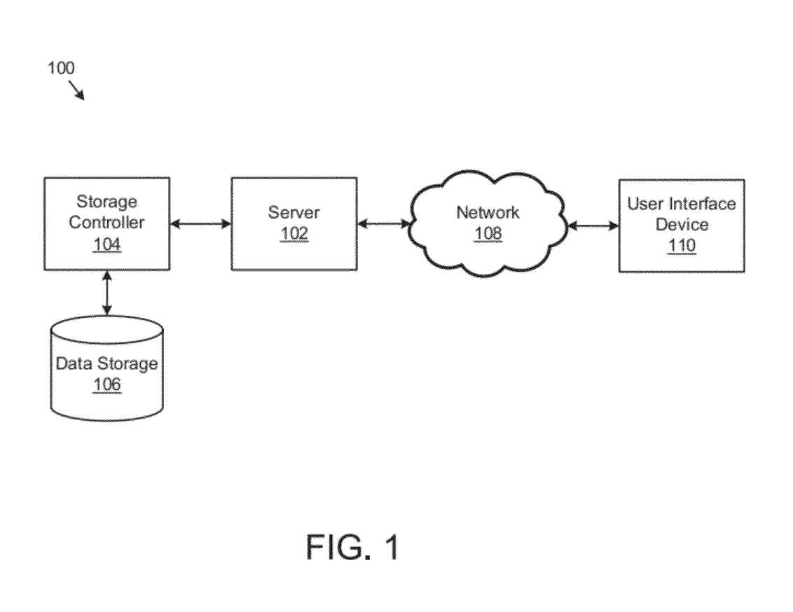

FIG. 1 illustrates one embodiment of a system 100 for adaptive batch mode active learning. The system 100 may include a server 102, a data storage device 104, a network 108, and a user interface device 110. In a further embodiment, the system 100 may include a storage controller 106, or storage server configured to manage data communications between the data storage device 104, and the server 102 or other components in communication with the network 108. In an alternative embodiment, the storage controller 106 may be coupled to the network 108. In a general embodiment, the system 100 may be configured to perform instructions such as those described in FIG. 4.

The user interface device 110 is referred to broadly and is intended to encompass at least a suitable processor-based device such as a desktop computer, a laptop computer, a tablet computer, a Personal Digital Assistant (PDA), a mobile communication device, an organizer device, or the like. In a further embodiment, the user interface device 110 may access the Internet to access a web application or web service hosted by the server 102 and provide a user interface for enabling a user to enter or receive information. For example, the user may enter commands to retrieve one or more datasets comprising a plurality of unlabeled data elements to be analyzed.

The network 108 may facilitate communications of data between the server 102 and the user interface device 110. The network 108 may include any type of communications network including, but not limited to, a wireless communication link, a direct PC to PC connection, a local area network (LAN), a wide area network (WAN), a modem to modem connection, the Internet, a combination of the above, or any other communications network now known or later developed within the networking arts which permits two or more computers to communicate with another.

In some embodiments, the server 102 may be configured to perform instructions such as those described in FIG. 4. Additionally, the server 102 may access data stored in the data storage device 104 via a Storage Area Network (SAN) connection, a LAN, a data bus, a wireless link, or the like.

The data storage device 104 may include a hard disk, including hard disks arranged in an Redundant Array of Independent Disks (RAID) array, a tape storage drive comprising a magnetic tape data storage device, an optical storage device, or the like. In some embodiments, the data storage device 104 may store health related data, such as insurance claims data, consumer data, or the like. The data may be arranged in a database and accessible through Structured Query Language (SQL) queries, or other data base query languages or operations.

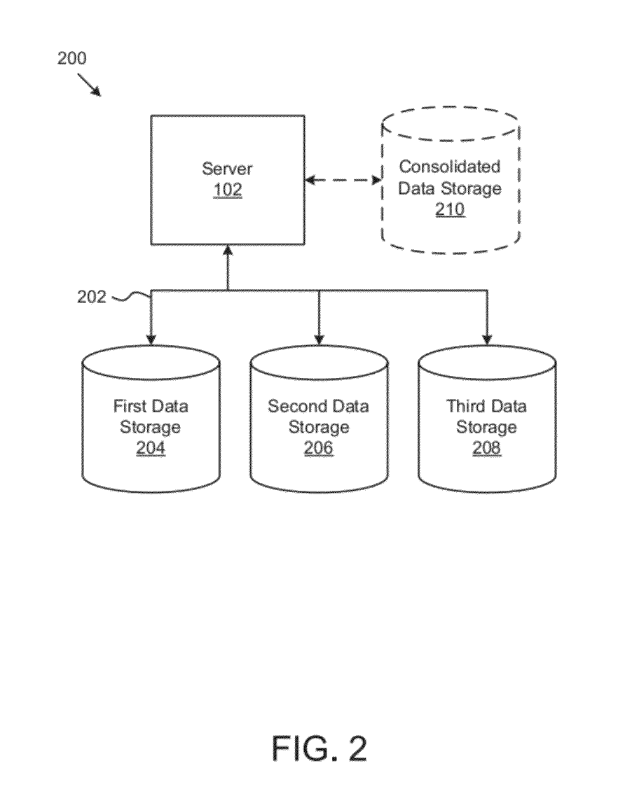

FIG. 2 illustrates one embodiment of a data management system 200 configured to store and manage data for adaptive batch mode active learning. In some embodiments, the system 200 may include a server 102. The server 102 may be coupled to a data-bus 202. In some embodiments, the system 200 may also include a first data storage device 204, a second data storage device 206 and/or a third data storage device 208. In other embodiments, the system 200 may include additional data storage devices (not shown) to store datasets to be analyzed. The storage devices 204-208 may be arranged in a RAID configuration for storing redundant copies of the database or databases through either synchronous or asynchronous redundancy updates.

In some embodiments, the server 102 may submit a query to selected data storage devices 204-206 to collect a consolidated set of data elements associated with an individual or group of individuals. The server 102 may store the consolidated data set in a consolidated data storage device 210. In such an embodiment, the server 102 may refer back to the consolidated data storage device 210 to obtain a set of data elements associated with a specified individual. Alternatively, the server 102 may query each of the data storage devices 204-208 independently or in a distributed query to obtain the set of data elements associated with a specified individual. In another alternative embodiment, multiple databases may be stored on a single consolidated data storage device 210.

In various embodiments, the server 102 may communicate with the data storage devices 204-210 over the data bus 202. The data bus 202 may comprise a SAN, a LAN, a wireless connection, or the like. The communication infrastructure may include Ethernet, Fibre-Channel Arbitrated Loop (FC-AL), Small Computer System Interface (SCSI), and/or other similar data communication schemes associated with data storage and communication. For example, the server 102 may communicate indirectly with the data storage devices 204-210, the server first communicating with a storage server or storage controller 106.

The server 102 may host a software application configured for adaptive batch mode active learning. The software application may further include modules for interfacing with the data storage devices 204-210, interfacing a network 108, interfacing with a user, and the like. In some embodiments, the server 102 may host an engine, application plug-in, or application programming interface (API). In another embodiment, the server 102 may host a web service or web accessible software application.

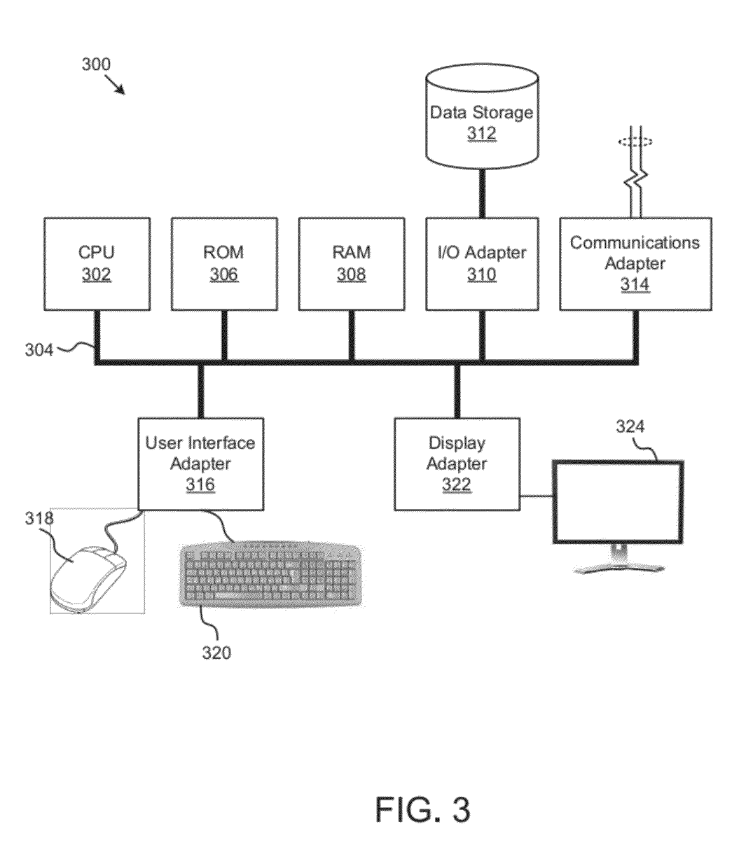

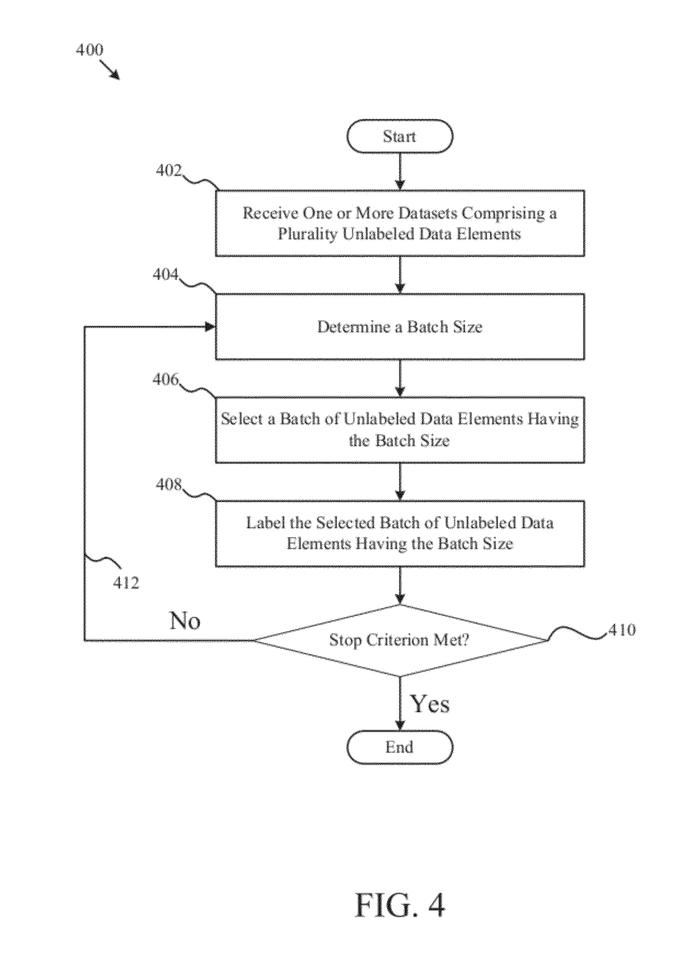

FIG. 3 illustrates a computer system 300 according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute various logical instructions according to disclosed embodiments. For example, the CPU 302 may execute machine-level instructions according to the exemplary operations described below with reference to FIG. 4.

The computer system 300 may include Random Access Memory (RAM) 308, which may be SRAM, DRAM, SDRAM, or the like. The computer system 300 may utilize RAM 308 to store the various data structures used by a software application configured for adaptive batch mode active learning. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information for data elements to be analyzed. In a further embodiment, the display adapter 322 may display a graphical user interface associated with a software or web-based application for adaptive batch mode active learning.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 108, which may be one or more of a wireless link, a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

Disclosed embodiments are not limited to the architecture of system 300. Rather the computer system 300 is provided as an example of one type of computing device that may be adapted to perform functions of a server 102 and/or the user interface device 110. For example, any suitable processor-based device may be utilized including without limitation, including smart phones, tablet computers, personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the disclosed embodiments.

The schematic flow chart diagrams that follow are generally set forth as logical flow chart diagrams. As such, the depicted order and labeled steps are indicative of some of the present embodiments. Other steps and methods may be employed that vary in some details from the illustrated embodiment (e.g., that are equivalent in function, logic, and/or effect). Additionally, the format and symbols employed are provided to explain logical steps and should be understood as non-limiting the scope of an invention. Although various arrow types and line types may be employed in the flow chart diagrams, they should be understood as non-limiting the scope of the corresponding method. Indeed, some arrows or other connectors may be used to indicate only the logical flow of the method. For instance, an arrow may indicate a waiting or monitoring period of unspecified duration between enumerated steps. Additionally, the order in which a particular method occurs may or may not strictly adhere to the order of the corresponding steps shown.

FIG. 4 illustrates one embodiment of a method 400 for adaptive batch mode active learning for evolving a classifier. Method 400 may be performed by processors, apparatuses, systems, such as those disclosed in FIGS. 1-3. Method 400 may be performed on a stand-alone apparatus and/or system, or by a plurality of apparatuses and/or systems connected together through a network, wired or wireless, such as a LAN, a WAN, a MAN, or the like. In some embodiments, method 400 comprises receiving 402 one or more datasets which comprise a plurality unlabeled data elements. The data elements may be any kind of digital data. For example text data (where a model needs to be trained to categorize text documents into different classes based on their contents or to classify an email as spam/non-spam based on its content), web-page classification (where a web-page needs to be assigned into a specific category), content based image retrieval (CBIR) (where relevant images need to be retrieved from a vast collection, based on given keywords), image recognition (where a classifier needs to be developed to recognize images like medical images, objects, facial expressions, facial poses among others), video data, or the like.

At step 404, a batch size is determined, of which a batch of unlabeled data elements would be analyzed next. The batch size may be determined based on evaluating a score function/an objective function. For example, the batch size may be selected such that an objective function is maximized or minimized. The maximization or minimization may be subject to one or more constraints. The objective function may based on distances between a batch of unlabeled data elements having the batch size in the plurality of unlabeled data elements and remaining unlabeled data elements in the plurality of unlabeled data elements. The distance between two data elements may be evaluated by, for example, Euclidean distance, zero norm, or the like.

At step 406, a batch of unlabeled data elements having the batch size (as determined in step 404) are selected from the plurality of unlabeled data elements. In some embodiments, the selection of a batch of unlabeled data elements having a specific batch size may be based on evaluating an objective function, such as an objective function described above. In some embodiments, the determination of a batch size and selection of a batch of unlabeled data elements having the batch size may be based on a single objective function.

At step 408, the selected batch of unlabeled data elements having the determined batch size is labeled, for example, by a classifier, where each data element is associated with a label which indicates a class to which the data element belongs. After the selected batch of unlabeled data elements having the batch size is labeled, this batch of labeled data may be appended to previously labeled data and together used to train the classifier and thereby update the classifier.

At step 412, it is determined whether a stop criterion has been met. If not, steps 404-410 are repeated for the plurality of unlabeled data elements until a stop criterion has been met. A stop criterion may be all the data elements in the plurality of unlabeled data elements have been labeled, or a certain percentage of the plurality of unlabeled data elements have been labeled, or a certain accuracy of classification has been obtained on the plurality of unlabeled data elements, or the like.

### EXAMPLES

The following describe scenarios that may be used with various embodiments of the disclosed invention. These examples are not intended to be limiting, but rather to provide specific uses for different embodiments of the disclosed invention.

### Dynamic BMAL

### Mathematical Formulation

### Optimization Based Dynamic BMAL

Consider a BMAL problem which has a current labeled set Lₜ and a current classifier w^{t} trained on Lₜ. The classifier is exposed to an unlabeled video Uₜ at time t. The objective is to select a batch B from the unlabeled stream in such a way that the classifier w^{t+1}, at time t+1, trained on LₜU B has maximum generalization capability. An efficient method to judge the generalization capability of the updated learner is to compute its entropy on the remaining set of Uₜ−B images after batch selection (given that future data is unknown). To ensure high generalization power of the future learner, one way is to minimize the entropy of the updated learner on the remaining |Uₜ−B| images.

From a data geometry point of view, it is possible that an objective function with only the entropy criterion will select images from high-density regions in the space of the unlabeled data points. This is because, the set of Uₜ−B images may be dominated by samples from such high-density regions constituting a large portion of the data. To address this issue, a condition is imposed in the objective function which selects images from low-density regions in the data space, i.e. images that have a high distance from the remaining set. The objective function described in this disclosure can be suitably modified for a different application, wherein the same optimization based dynamic BMAL strategy can be used for batch selection.

Let C denote the total number of classes and pⱼ denote the average Euclidean distance of an unlabeled image xⱼ from other images in the video Uₜ. Greater values of pⱼ denote that the point is located in a low-density region. The two conditions mentioned previously can be satisfied by defining a score function as follows:

$$f ( B ) = {\sum }_{j ∈ B} {ρ}_{j} - {λ}_{1} {\sum }_{j ∈ {U}_{t} - B} S ( y \vert {x}_{j} , {w}^{t + 1} ) \qquad ( 1 )$$

The first term denotes the sum of the average distances of each selected point from other points in the unlabeled video, while the second term quantifies the sum of the entropies of the learner on each remaining point in the unlabeled stream. λ₁ is a tradeoff parameter.

The problem therefore reduces to selecting a batch B of unlabeled images which produces the maximum score f(B). Let the batch size (number of images to be selected for annotation) be denoted by m, which is an unknown. Since there is no restriction on the batch size m, the obvious solution to this problem is to select all the images in the unlabeled video, leaving no image behind. Then, the entropy term becomes 0, and the density term attains its maximum value. Consequently, f(B) will also attain its maximum score. However, querying all the images for their class labels is not an elegant solution and defeats the basic purpose of active learning. To prevent this, the objective/score function is modified by enforcing a penalty on the batch size as follows:

$$\tilde{f} ( B ) = {\sum }_{j ∈ B} {ρ}_{j} - {λ}_{1} {\sum }_{j ∈ {U}_{t} - B} S ( y \vert {x}_{j} , {w}^{t + 1} ) - {λ}_{2} m \qquad ( 2 )$$

The third term essentially reflects the cost associated with labeling the images, as the value of the objective function decreases with every single image that needs to be labeled. The extent of labeling penalty can be controlled through the weighting parameter λ₂. Defining the score function in this way ensures that any and every image is not queried for its class label. Only images for which the density and entropy terms outweigh the labeling cost term, get selected.

Next there is a need to select a batch B of unlabeled images so as to maximize \tilde{f}(B). Since brute force search methods are prohibitive, the method employs numerical optimization techniques to solve this problem. In this regard, a binary vector M of size |Uₜ| is defined where each entry denotes whether the corresponding point is to be queried for its class label and the objective function in Equation 2 is rewritten into an equivalent function in terms of the defined vector M:

$${max}_{M , m} {\sum }_{j ∈ {U}_{t}} {ρ}_{j} {M}_{j} - {λ}_{1} {\sum }_{j ∈ {U}_{t}} ( 1 - {M}_{j} ) S ( y \vert {x}_{j} , {w}^{t + 1} ) - {λ}_{2} m \qquad ( 3 )$$

subject to the constraint:

Mⱼε{0,1}∀j (4)

In this formulation, note that if an entry of M is 1, the corresponding image will be selected for annotation and if it is 0, the image will not be selected. The number of images to be selected, is therefore equal to the number of non-zero entries in the vector M, or the zero-norm of M. Hence,

$$m = {‖ M ‖}_{0} \approx {‖ M ‖}_{1} = {\sum }_{j} {M}_{j} \qquad ( 5 )$$

The zero norm of M is replaced by its tightest convex approximation, which is the one-norm of M (similar to (Weston et al., 2003). Also, from constraint 4, the one-norm is simply the sum of the elements of the vector M. Substituting m in terms of M, the formulation becomes:

$${max}_{M} {\sum }_{j ∈ {U}_{t}} {ρ}_{j} {M}_{j} - {λ}_{1} {\sum }_{j ∈ {U}_{t}} ( 1 - {M}_{j} ) S ( y \vert {x}_{j} , {w}^{t + 1} ) - {λ}_{2} {\sum }_{j} {M}_{j}$$

subject to the constraint:

Mⱼε{0,1}∀j

The above optimization is an integer programming problem and is NP hard. The constraint is relaxed to make it a continuous optimization problem:

$${max}_{M} {\sum }_{j ∈ {U}_{t}} {ρ}_{j} {M}_{j} - {λ}_{1} {\sum }_{j ∈ {U}_{t}} ( 1 - {M}_{j} ) S ( y \vert {x}_{j} , {w}^{t + 1} ) - {λ}_{2} {\sum }_{j} {M}_{j} \qquad ( 6 )$$

subject to the constraint: 0≦Mⱼ≦1.

This problem is solved using the Quasi Newton method (Nocedal and Wright, 1999). The final value of M is used to govern the number of points and the specific points to be selected for the given data stream (by greedily setting the top m entries in M as 1 to recover the integer solution, where m=ΣⱼMⱼ). Hence, solving a single optimization problem helps in dynamically deciding the batch size and selecting the specific points for manual labeling.

Optimization based dynamic BMAL can be extended for dynamic batch selection in situations where multiple sources of information (e.g. audio and video data) are available. For instance, Equation (6) can be modified by appending relevant terms from the respective sources, together with a penalty on the batch size:

$${max}_{M} {\sum }_{j ∈ {U}_{t 1}} {ρ}_{j} {M}_{j} - {\sum }_{j ∈ {U}_{t 1}} ( 1 - {M}_{j} ) S ( y \vert {x}_{j} , {w}^{t + 1} ) + {\sum }_{j ∈ {U}_{t 2}} {ρ}_{j} {M}_{j} - {\sum }_{j ∈ {U}_{t 2}} ( 1 - {M}_{j} ) S ( y \vert {x}_{j} , {w}^{t + 1} ) - {\sum }_{j} {M}_{j}$$

Moreover, if contextual information is available (e.g. location of a subject, whether at home or in office), it can be used to construct a prior probability vector depicting the chances of seeing particular acquaintances in a given context. The entropy term can then be computed on the posterior probabilities obtained by multiplying the likelihood values returned by the classifier with the context aware prior. Thus, subjects not expected in a given context (e.g. a home acquaintance in an office setting) will have low priors and consequently, the corresponding posteriors will not contribute much in the entropy calculation. The framework can therefore be extended to perform context-aware adaptive batch selection. The preliminary studies in these directions have shown promising results.

While the proposed framework combines batch size and data sample selection in a single formulation, it is also possible to think of an intuitive approach to solve this problem using a clustering-based batch size selection step, followed by application of a traditional static BMAL algorithm (such as (Guo and Schuurmans, 2007)). For purposes of comparison of performance, the discussion below presents an alternative clustering-based approach for selecting the batch size in the latter case.

### Clustering-Based Batch Size Selection

A strategy to decide the batch size is to use a clustering algorithm to segment the images in the unlabeled video stream followed by a method to compute the batch size. Since the number of subjects (and hence, the number of clusters) in the data stream is an unknown, there is a need to exploit the spatial distribution of the unlabeled points for clustering (and cannot use algorithms like k-means which require the number of clusters as an input). This motivates the application of the DBSCAN algorithm (which can automatically determine the number of clusters for a given set of points) to isolate high density regions as separate clusters. For details about this method, please refer (Tan et al., 2006). The initial studies (not presented here for brevity) confirmed the efficacy of DBSCAN in isolating images of different subjects into separate clusters.

The Silhouette Coefficient (based on the cohesion and separation measures of a cluster) is a natural choice to decide the number of points to be queried from each cluster. It can attain a maximum value of 1, where a high value denotes a compact and well separated cluster. In some cases, it is best to select few points for a compact and well-separated cluster and more points otherwise. Thus, the number of points to be selected from a cluster should be proportional to (1—the Silhouette coefficient). Also, there may be benefits to selecting more points from larger clusters. If m is the total number of points, mᵢ is the number of points in cluster i, SCᵢ is the Silhouette coefficient of cluster i and C is a constant, the number of points to be selected from cluster i can thus be defined as:

$${N}_{i} = C * \frac{{m}_{i}}{m} * ( 1 - {SC}_{i} ) \qquad ( 7 )$$

This operation is performed for each of the identified clusters to compute the number of points to be selected (the sum of the values obtained across all clusters provides the overall batch size). The dynamically computed batch size for each cluster can now be passed as an input to any standard static BMAL procedure for selecting the required number of points from the corresponding cluster.

### Studies and Results

The study consisted of three studies to validate the efficiency of the framework. Using preliminary studies, the parameters λ₁ and λ₂ were empirically set to 1 and C to 50 in the study. The entropy term in the objective function necessitates a classifier which can provide probability estimates of an unlabeled point with respect to all classes. So, Gaussian Mixture Models (GMMs) were used as the classifier in the studies. GMMs have been successfully used in face recognition (Kim et al., 2004) in earlier work.

### Datasets

Due to the high frame rate of modern cameras, video data has a lot of redundancy and hence, video based person recognition is taken as the exemplar application in this disclosure to describe the framework. Four challenging biometric datasets were used in the different studies:
(i) The VidTIMIT dataset (Sanderson, 2008), which contains video recordings of subjects reciting short sentences under unconstrained natural conditions.
(ii) The MOBIO dataset (Marcel et al., 2010), which was recently created for the MOBIO (Mobile Biometry) challenge to test state-of-the-art face and speech recognition algorithms. It contains recordings of subjects under challenging real world conditions, captured using a hand-held device.
(iii) The MBGC (Multiple Biometric Grand Challenge) dataset (Tistarelli and Nixon, 2009), collected by the National Institute of Standards and Technology (NIST), which is the leading dataset to test commercial biometric recognition algorithms and contains video recordings of subjects under uncontrolled indoor and outdoor lighting.
(iv) The FacePix dataset (www.facepix.org), which contains 181 (−90 degree to 90 degree) pose images of each of 30 subjects in one degree increments. It also contains frontal images of each subject under varying illumination, where a spotlight was moved in one degree increments. The dataset has been used to study the effects of varying poses and illumination angles in face recognition (Little et al., 2005).

The VidTIMIT, MOBIO and MBGC datasets represent videos captured under different real world settings (stationary, using handheld device and under uncontrolled lighting respectively). FacePix contains calibrated measurements of pose and illumination variations, which were useful to study the efficacy of the framework.

### Study 1: Dynamic Vs Static BMAL

The purpose of this study was to demonstrate the efficacy of dynamic batch selection over static selection in applications like face recognition. The VidTIMIT and the MOBIO biometric datasets were used in this study. 25 subjects were randomly selected from each dataset. The preliminary studies (not presented here due to lack of space) confirmed that the Discrete Cosine Transform (DCT) feature could effectively differentiate the subjects and hence was used in this study (for details about the feature extraction process, please refer (Ekenel et al., 2007)). The feature extraction step was followed by PCA to reduce the dimension.

A classifier was induced with 1 training video of each of the 25 subjects, used in this study. Unlabeled video streams were then presented to the learner. To demonstrate the generalizability with different subject combinations, the number of subjects in each unlabeled stream was varied between 1 and 10. For each stream, the batch size and the specific points were selected simultaneously using the proposed optimization strategy (Equation 6). The classifier was updated with the selected points and tested on test videos containing the same subject(s) as in the corresponding unlabeled videos.

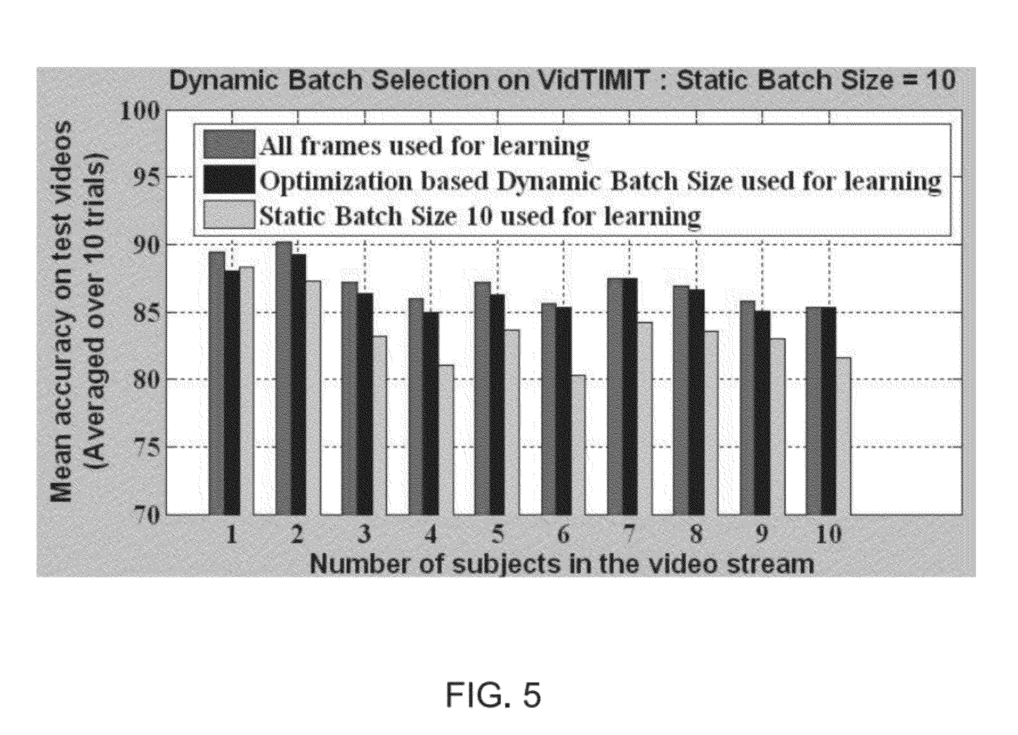

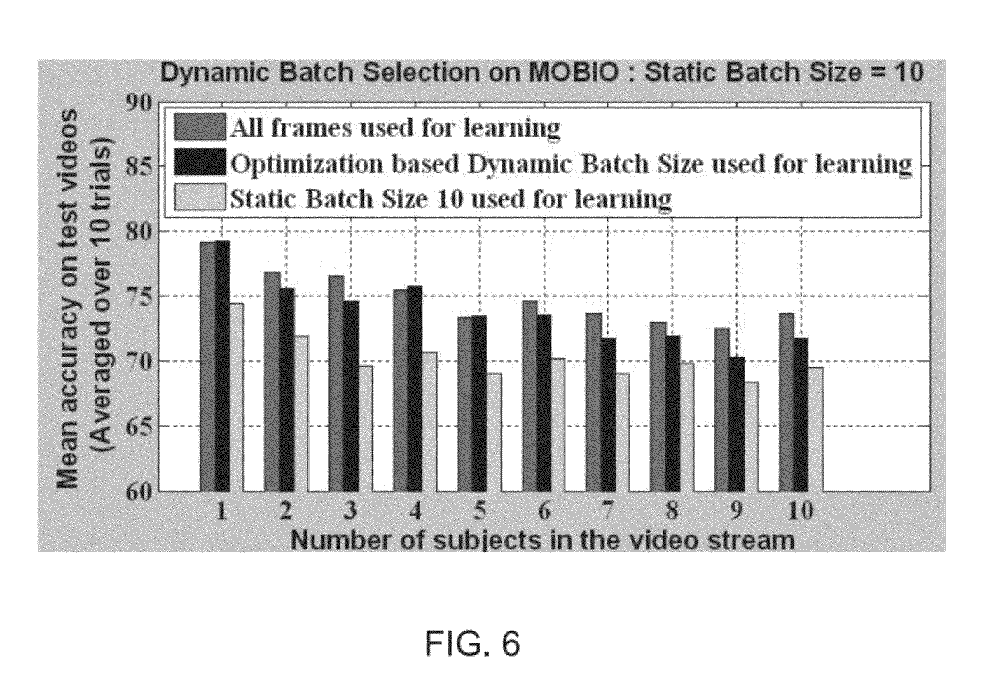

To illustrate the usefulness of dynamic batch size selection, the accuracy was compared against the case when all the frames in the unlabeled video were used for learning and also when the batch size was static and predetermined. The static batch size was selected as 10 (the effect of this parameter is studied later) and the optimization scheme was used to select the 10 points, for fair comparison. The results are shown in FIGS. 5-6 and are averaged over 10 runs to rule out effects of randomness. In both datasets, the accuracy obtained with dynamic batch selection very closely matches that obtained when trained on all the frames. This emphasizes the efficiency of the framework to properly identify a batch size and the specific points so that the resulting classifier is comparable to the one trained using all the images. The classifier obtained when the batch size is static and pre-determined does not attain good generalization capability compared to dynamic selection.

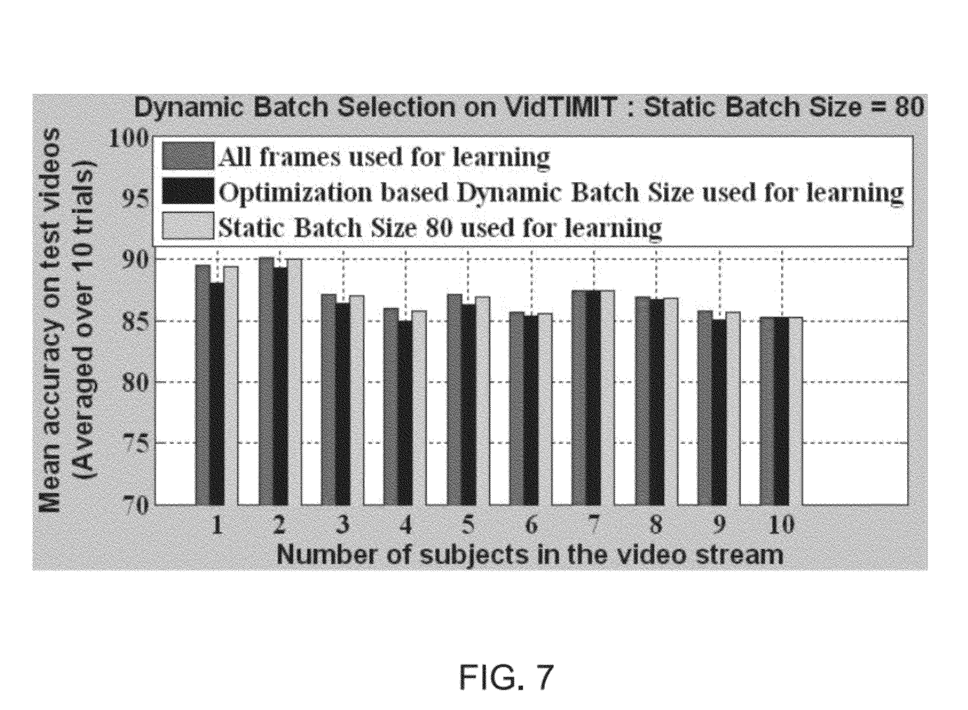

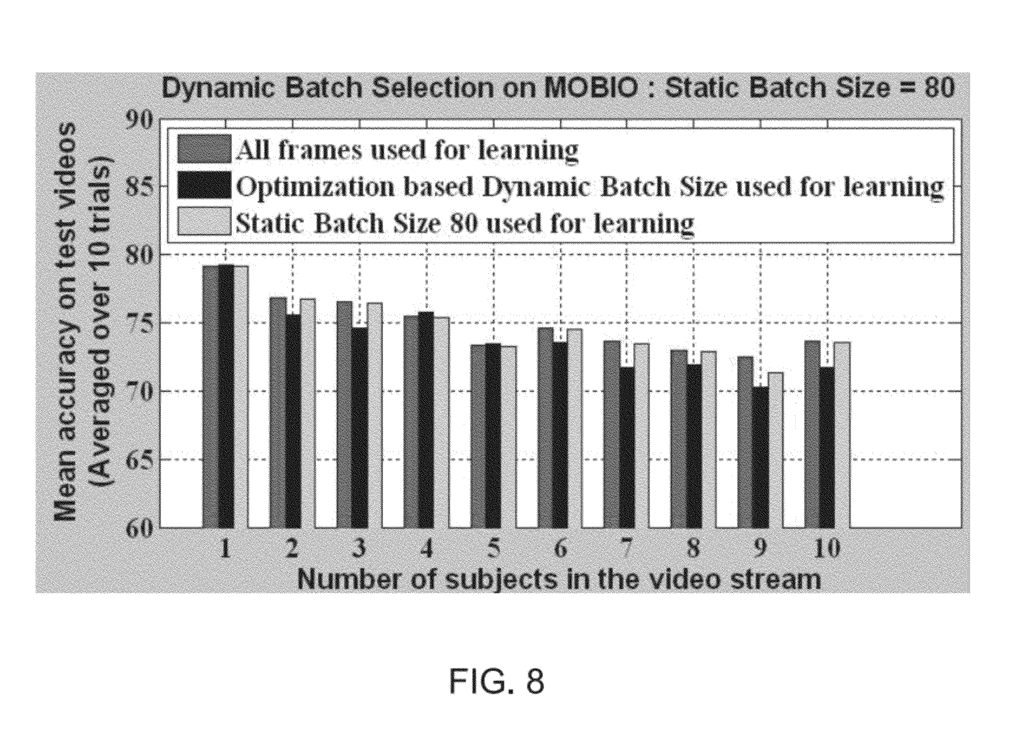

In general, upon selection of a greater number of images from an unlabeled set, the updated learner will perform better on a test set containing the same subjects. Thus, if a higher value of the batch size in a static BMAL learner is selected, then the selection would be expected to perform better than in FIGS. 5-6. This is depicted in FIGS. 7-8 where the static batch size was taken as 80 instead of 10. The static selection performs almost as well as the learner obtained when trained on all frames. However, to achieve this performance, the static selection required a significantly greater number of images to be labeled than dynamic selection. Table 1 shows the mean percentage increment in the number of images that had to be labeled using the static selection with batch size 80 against optimization based dynamic selection. It is evident that for both the datasets, the static framework required a much greater number of images to be labeled to marginally outweigh dynamic selection. Hence, by selecting a number at random, the static batch selection strategy can sometimes query too few points leading to poor generalization power of the updated learner, while in some cases it can entail considerable labeling cost to attain an insignificant increment in accuracy. The dynamic selection strategy, on the other hand, computes the batch size by exploiting the level of confidence of the future learner on the images in the current unlabeled video and thus provides a concrete basis to decide the batch size.

TABLE 1
Mean percent increment in labeling cost using static selection with batch size 80
against optimization based dynamic selection

| | No. of subjects in the video stream | | | | | | | | | |
|---|---|---|---|---|---|---|---|---|---|---|
| | 1 | 2 | 3 | 4 | 5 | 6 | 7 | 8 | 9 | 10 |
| VidTIMIT | 58% | 68.1% | 55.58% | 45.46% | 51.11% | 35.71% | 35.88% | 41.38% | 51.93% | 47.43% |
| dataset | | | | | | | | | | |
| MOBIO | 54.4% | 48.4% | 45.4% | 45.4% | 45.1% | 46.8% | 46.5% | 46.8% | 46.4% | 44.6% |
| dataset | | | | | | | | | | |

### Study 2: Proposed Dynamic BMAL Vs Clustering-Based Dynamic BMAL

A comparative study of the proposed optimization framework was performed with the two step process of clustering followed by static BMAL for dynamic batch selection. The VidTIMIT and MBGC datasets were used in this study. Contrary to the previous study, where all the 25 subjects were present in the training set, the subjects in this study were divided into two groups—a “known” group containing 20 subjects and an “unknown” group containing the remaining 5 subjects. A classifier was induced with 1 video of each of the known subjects. Unlabeled video streams were then presented to the learner and the batch size decided by the two schemes were noted. The proportion of unknown subjects in the unlabeled video was gradually increased from 0% (where all the subjects in the unlabeled video were from the training set) to 100% (where none of the subjects in the unlabeled video were present in the training set) in steps of 20%. The learner was not given any information about the composition of the video stream. Also, the size of each video stream was kept the same to facilitate fair comparison. The DCT feature, followed by PCA, was used again.

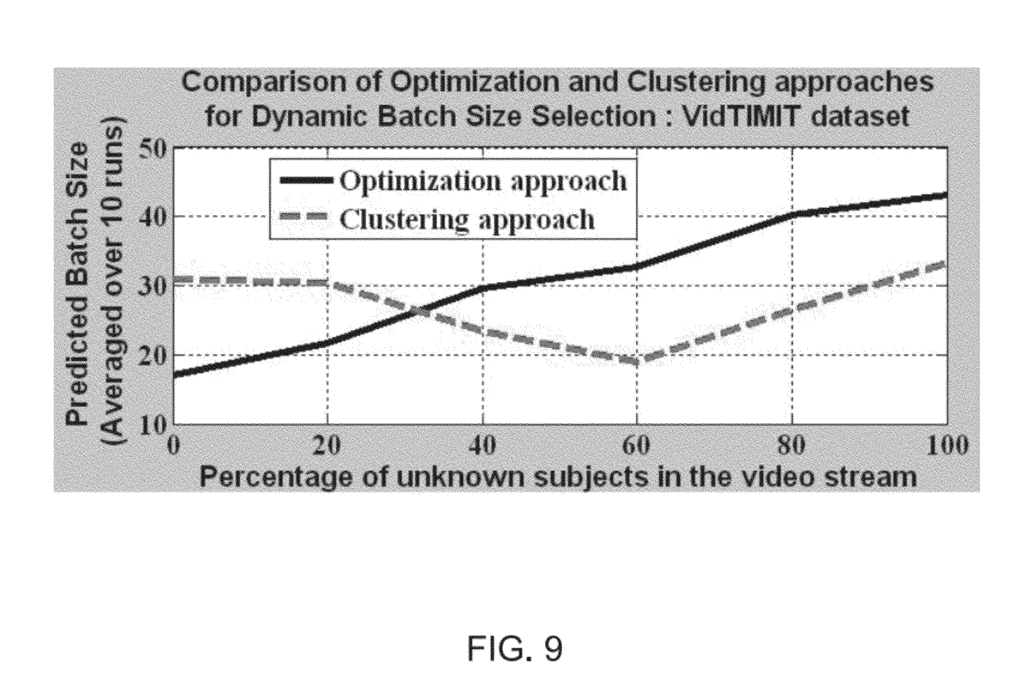

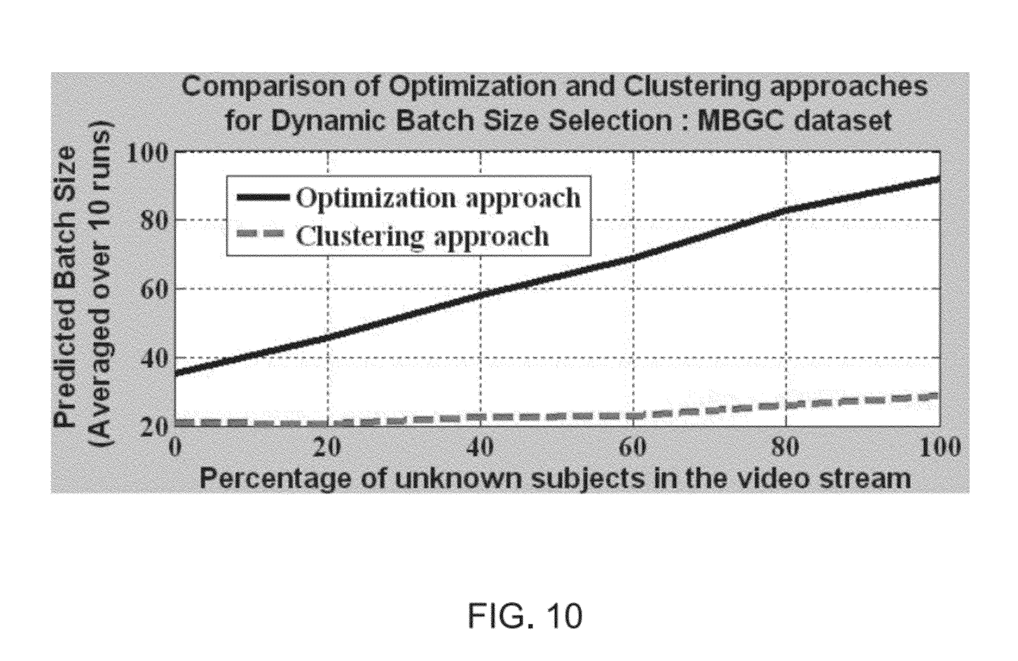

The results of the aforementioned study (averaged over 10 trials) are shown in FIGS. 9-10. The x-axis denotes the percentage of atypical images in the unlabeled pool and the y-axis denotes the batch size predicted using both the proposed and clustering-based strategies. In both the studies, as the proportion of salient images in the unlabeled stream increases, the uncertainty term outweighs the cost term in Equation 6 and the proposed algorithm decides on a larger batch size. This matches the intuition because, with growing percentages of atypical images in the video stream, the confidence of the learner on those images decreases and so it needs to query more images to attain good generalization capability. The clustering based scheme, on the other hand, does not consider the training set in deciding the batch size and so, it fails to reflect the uncertainty of the classifier. The batch size, therefore, does not bear any specific trend to the percentage of atypical images in the unlabeled set. Thus, while the clustering scheme decides the number of points to be queried based on a score computed from the spatial distribution of the unlabeled points, the optimization based technique provides a more logical ground to decide the batch size by considering the performance of the updated learner.

Besides the predicted batch size, it is equally important to analyze the accuracy obtained on test sets with similar compositions as the unlabeled videos. Since the proposed scheme appropriately reflects the uncertainty of the learner and queries points accordingly, it is expected to have a better accuracy on test videos as compared to the clustering technique. This is confirmed in Table 2 which shows the accuracy obtained on test videos from the MBGC dataset using the two strategies. It is evident that the proposed scheme achieved significantly better generalization as compared to the clustering based approach with varying proportions of new identities in the unlabeled stream. The result on the VidTIMIT dataset was similar and is not presented due to lack of space.

TABLE 2
Test set accuracies using Proposed and Clustering base
BMAL on the MBGC data set with increasing proportions
of new identities

| | Proportion of new identities | | | | | |
|---|---|---|---|---|---|---|
| | 0% | 20% | 40% | 60% | 80% | 100% |
| Accuracy using | 87.1% | 79.9% | 82.8% | 84.6% | 86.6% | 81.8% |
| proposed | | | | | | |
| approach | | | | | | |
| Accuracy using | 84.1% | 68.4% | 61% | 53.4% | 63.8% | 63.9% |
| clustering | | | | | | |
| approach | | | | | | |

To further demonstrate the usefulness of the proposed approach in batch size selection under changing conditions, studies were conducted with unlabeled videos containing images with different poses and illumination conditions compared to the training images. These are detailed below:

Presence of images with unknown pose angles: The FacePix dataset was used in this study. The training set contained frontal images (−10 degree to 10 degree) of 25 randomly chosen subjects. Unlabeled sets of images of the same 25 subjects were presented to the learner and the percentage of profile images (−45 degree to −90 degree and 45 degree to 90 degree) was gradually increased from 0% (where all the unlabeled images were frontal) to 100% (where the unlabeled video contained only profile images) in steps of 20%. The Gabor feature was used here (as in Gokberk et al., 2002) and PCA was used to reduce the dimension.

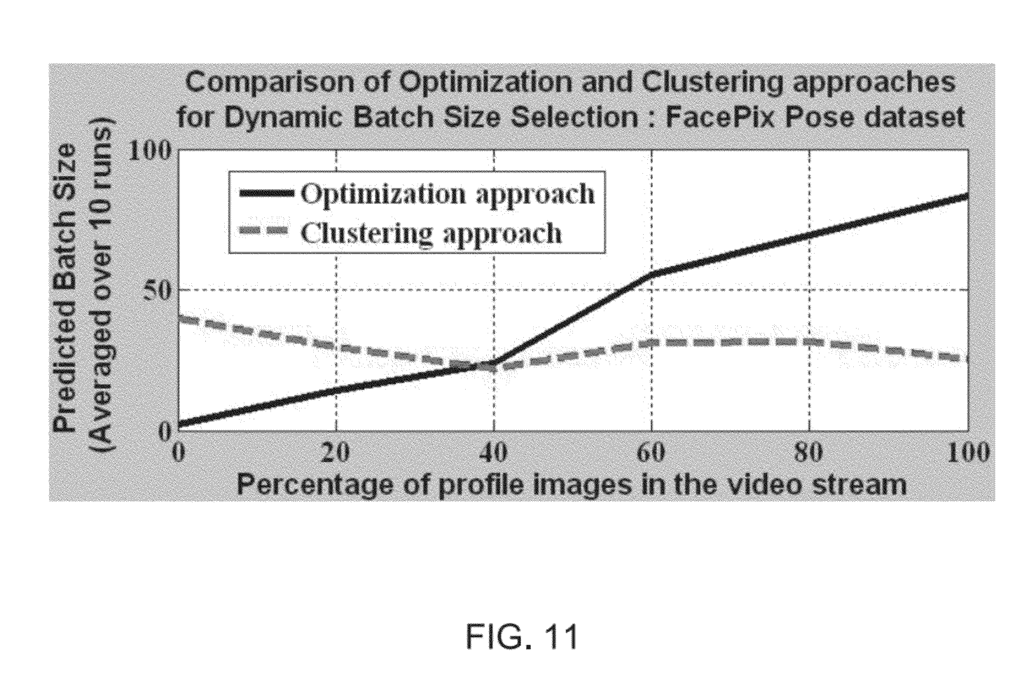

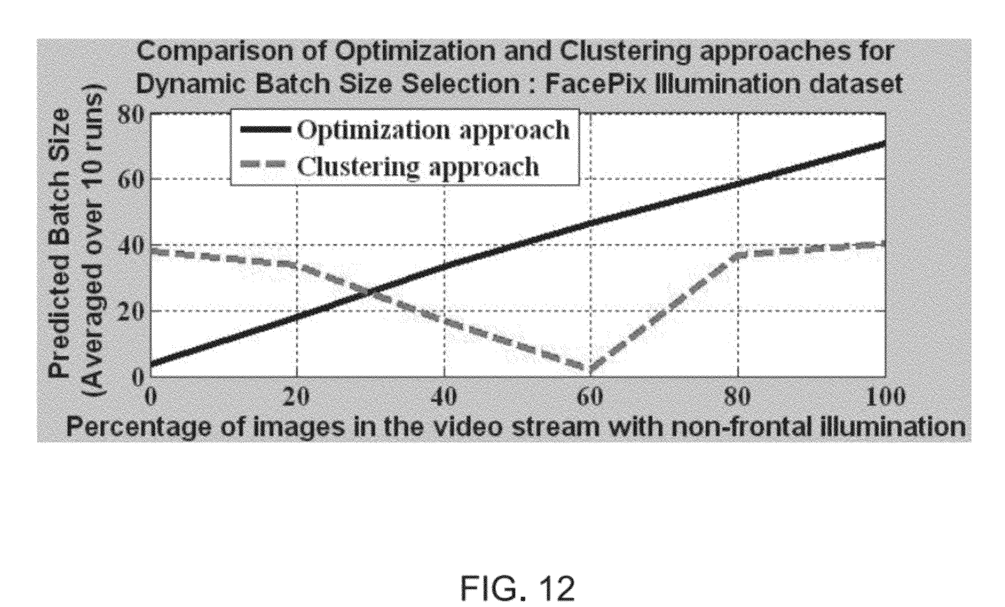

Presence of images under unknown illumination: The FacePix dataset was used in this study also. As before, the training set contained images of 25 subjects where the illumination angle was −10 degree to 10 degree. Unlabeled images of the same subjects were presented to the learner and the percentage of images where the angle of illumination varied between −45 degree to −90 degree and 45 degree to 90 degree was gradually increased from 0% to 100% in steps of 20%. The Gabor feature, followed by PCA, was used in this study (as used in Liu et al., 2005). The results are shown in FIGS. 11-12 and further corroborate the conclusions drawn in the previous study.

### Study 3: Active Learning Performance

The practical applicability of the end-to-end system was studied by analyzing its performance under real world settings. The VidTIMIT and the MOBIO datasets, representing challenging real-world conditions, were used in this study. A classifier was induced with 1 training video of each of 25 randomly chosen subjects. Unlabeled video streams (each containing about 250 frames) were then presented to the classifier sequentially. The images in the video streams were randomly chosen from all 25 subjects and did not have any particular proportion of subjects in them, to mimic general real-world conditions. For each video, optimization based dynamic BMAL was used to query images. The selected images were appended to the training set, the classifier updated and then tested on a test video containing about 5000 images spanning all the 25 subjects.

The proposed approach was compared with three heuristic BMAL schemes—(i) Random Sampling, (ii) Diversity based BMAL, as proposed by Brinker (2003) and (iii) Uncertainty Based Ranked Selection, where the top k uncertain points were queried from the unlabeled video, k being the batch size. For each video stream, the dynamically computed batch size was noted and used for the corresponding unlabeled video in each of the heuristic techniques, for fair comparison. The performance was also compared against the two step process of clustering followed by static BMAL.

The label complexity (number of batches of labeled examples needed to achieve a certain level of accuracy) was used as the metric for quantifying performance in this study. The average time taken by each approach, to query images from an unlabeled stream, was also noted. The results are shown in Table 3. As evident from the running time figures, the proposed approach is computationally intensive compared to the heuristic BMAL techniques. However, the label complexity values to attain a test accuracy of 85% is markedly lower for the proposed approach. This asserts the fact that the proposed scheme succeeds in selecting the salient and prototypical data points as compared to the heuristic approaches and attains a given level of accuracy with significantly reduced human labeling effort. The clustering scheme followed by the optimization framework achieves comparable label complexity as the approach. However, it is a two step process and therefore involves more computation than the approach which is depicted in the running time values.

TABLE 3
Number of batches of labeled images required to achieve 85%
accuracy and the time taken (in seconds) to query a batch of images
from an unlabeled pool with 250 images. The results have been
averaged over 3 runs with different orders of the unlabeled
video streams.

| | VidTIMIT | VidTIMIT | MOBIO | MOBIO |
|---|---|---|---|---|
| | Label | Time | Label | Time |
| | Complexity | (Seconds) | Complexity | (Seconds) |
| Proposed Approach | 8.67 | 105.66 | 20.67 | 157.67 |
| Diversity based | 27.67 | 1.3 | 63.33 | 1.38 |
| BMAL | | | | |
| Uncertainty based | 23.67 | 13.98 | 44.67 | 21.46 |
| BMAL | | | | |
| Random Sampling | 31.33 | 0.01 | 61.67 | 0.01 |
| Clustering based | 11.33 | 122.11 | 22.67 | 174.28 |
| BMAL | | | | |

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

### REFERENCES

U.S. Patent Application NO. US 2010/0293117 A1
Balasubramanian et al., Generalized query by transduction for online active learning, in OLCV Workshop at ICCV, 2009.
Baram et al., Online choice of active learning, J. Machine Learn. Res., 255-291, 2004.
Brinker et al., Incorporating diversity in active learning with support vector machines, ICML, 59-66, 2003.
Cohn et al., Active learning with statistical models, J. Artif. Intell. Res. (JAIR), 4:129-145, 1996.
Ekenel et al., In: Multimodal person identification in a smart environment, IEEE CVPR, 2007.
Freund et al., Selective sampling using the query by committee algorithm, Machine Learning, 28:133-168, 1997.
Gokberk et al., Feature selection for pose invariant face recognition, IEEE ICPR, 4: 306-309, 2002.
Guo and Schuurmans, Discriminative batch mode active learning, in Advances in Neural Infor. Processing Sys. (NIPS), 2007.
Ho and Wechsler, Query by transduction, IEEE Trans. Pattern Anal. Machine Intell., 30(9):1557-1571, 2008
Hoi et al., Semi-supervised SVM batch mode active learning for image retrieval., IEEE CVPR, 1-7, 2008.
Hoi et al., Batch mode active learning and its application to medical image classification, ICML, 2006.
Hoi et al., Large-scale text categorization by batch mode active learning, Intl. Conf. World Wide Web. ACM, 2006.
Kim et al., Implementation and enhancement of GMM face recognition systems using flatness measure, Robot and Human Interactive Communication, 13^{th} IEEE Intl. Workshop, 247-251, 2004.
Liere and Tadepalli, Active learning with committees for text categorization, ICAI, 1997.
Little et al., A methodology for evaluating robustness of face recognition algorithms with respect to changes in pose and illumination angle, ICASSP, 2005.
Liu and Zhang, A fast algorithm for linearly constrained quadratic programming problems with lower and upper bounds, Intl. Conf. Multimedia and Info. Tech., 2008.
Liu et al., Illumination invariant face recognition, Pattern Recognition, 38:1705-1716, 2005.
Marcel et al., Mobile biometry (mobio) face and speaker verification evaluation, Idiap Research Inst., Tech. Rep., 2010.
McCallum and Nigam, Employing EM and Pool-Based active learning for text classification, ICML, 1998.
Monteleoni and Kaariainen, Practical online active learning for classification, IEEE CVPR, 2007.
Nocedal and Wright, Numerical optimization, series in Operation Research, Springer, 1-636, 1999.
Sanderson, Biometric Person Recognition: Face, Speech and Fusion, VDM Verlag, 2008.
Tan et al., Introduction to data mining, 2006.
Tistarelli and Nixon, Advances in Biometrics, Springer, 2009.
Tong and Koller, Support vector machine active learning with applications to text classification, J. Machine Learn. Res., 2:45-66, 2000.
Weston et al., Use of the zero norm with linear models and kernel methods, J. Machine Learn. Res., 1439-1461, 2003.

What is claimed is:

1. A method for adaptive batch mode active learning, the method comprising:
(a) receiving one or more datasets comprising a plurality unlabeled data elements;
(b) determining, using a processor, a batch size;
(c) selecting, using the processing, a batch of unlabeled data elements having the batch size from the plurality of unlabeled data elements;
(d) labeling, using a labeling agent, the batch of unlabeled data elements having the batch size; and
(e) repeating steps (b)-(e) for the plurality of unlabeled data elements until a stop criterion has been met.

2. The method of claim 1, where the batch size is determined based on evaluating an objective function.

3. The method of claim 2, where the objective function is based on distances between a batch of unlabeled data elements having the batch size in the plurality of unlabeled data elements and remaining unlabeled data elements in the plurality of unlabeled data elements.

4. The method of claim 1, where selecting a batch of unlabeled examples is based on evaluating an objective function.

5. The method of claim 4, where the objective function is based on distances between a selected batch of unlabeled data elements having the batch size in the plurality of unlabeled data elements and remaining unlabeled data elements in the plurality of unlabeled data elements.

6. The method of claim 1, where determining a batch size and selecting a batch of unlabeled data elements having the batch size are based on a single objective function.

7. The method of claim 1, where the plurality of unlabeled data elements comprises image data.

8. The method of claim 1, where the plurality of unlabeled data elements comprises audio data.

9. The method of claim 1, where the plurality of unlabeled data elements comprise at least one type of data selected from: image data, video data, text data, audio data, and web data.

10. The method of claim 1, wherein the labeling is performed by a classifier, and after the batch of unlabeled data elements having the batch size are labeled, updating the classifier by training the classifier with a set of labeled data elements, the set of labeled data elements comprising the batch of labeled data elements having the batch size.

11. The method of claim 1, where the stop criterion comprises every data element in the plurality of unlabeled data elements that has been labeled.

12. The method of claim 1, where the stop criterion comprises a predetermined classification accuracy for the plurality of unlabeled data elements.

13. A system for adaptive batch mode active learning, the system comprising a processor configured to perform:
(a) receiving one or more datasets comprising a plurality of unlabeled data elements;
(b) determining a batch size;
(c) selecting a batch of unlabeled data elements having the batch size from the plurality of unlabeled data elements;
(d) labeling the batch of unlabeled data elements having the batch size; and
(e) repeating steps (b)-(e) for the plurality of unlabeled data elements until a stop criterion has been met.

14. The system of claim 13, where the batch size is determined based on evaluating an objective function.

15. The system of claim 14, where the objective function is based on distances between a batch of unlabeled data elements having the batch size in the plurality of unlabeled data elements and remaining unlabeled data elements in the plurality of unlabeled data elements.

16. The system of claim 13, where selecting a batch of unlabeled data elements is based on evaluating an objective function.

17. The system of claim 16, where the objective function is based on distances between a batch of unlabeled data elements having the batch size in the plurality of unlabeled data elements and remaining unlabeled data elements in the plurality of unlabeled data elements.

18. The system of claim 13, where determining a batch size and selecting a batch of unlabeled data elements having the batch size are based on a single objective function.

19. The system of claim 13, where the plurality of unlabeled data elements comprises image data.

20. The system of claim 13, where the plurality of unlabeled data elements comprises audio data.

21. The system of claim 13, where the plurality of unlabeled data elements comprises at least one type of data selected from: image data, video data, text data, audio data, and web data.

22. The system of claim 13, where the labeling is performed by a classifier, and after the batch of unlabeled data elements having the batch size are labeled, updating the classifier by training the classifier with a set of labeled data elements, the set of labeled data elements comprising the batch of labeled data elements having the batch size.

23. The system of claim 13, where the stop criterion comprises every data element in the plurality of unlabeled data elements that has been labeled.

24. The system of claim 13, where the stop criterion comprises a predetermined classification accuracy for the plurality of unlabeled data elements.

25. A non-transitory computer-readable medium embodying one or more sets of instructions executable by one or more processors, the one or more sets of instructions configured to perform:
(a) receiving one or more datasets comprising a plurality of unlabeled data elements;
(b) determining a batch size;
(c) selecting a batch of unlabeled data elements having the batch size from the plurality of unlabeled data elements;
(d) labeling the batch of unlabeled data elements having the batch size; and
(e) repeating steps (b)-(e) for the plurality of unlabeled data elements until a stop criterion has been met.

26. The computer-readable medium of claim 25, where the plurality of unlabeled data elements comprises video data.

27. The computer-readable medium of claim 25, where the plurality of unlabeled data elements comprises image data.

28. The computer-readable medium of claim 25, where the plurality of unlabeled data elements comprises at least one type of data selected from: image data, video data, text data, audio data, and web data.

29. The computer-readable medium of claim 25, where determining a batch size and selecting a batch of unlabeled data elements having the batch size are based on a single objective function.
